(19) United States
(12) Patent Application Publication
(10) Pub. No.: US 2016/0139729 A1
(43) Pub. Date: May 19, 2016

(54) METHODS IN COMPUTING DEVICES

(71) Applicant: Solu Machines Oy, Helsinki (FI)

(72) Inventors: Joona KALLIO, Espoo (FI); Kristoffer LAWSON, Espoo (FI); Pekka NIKANDER, Helsinki (FI); Javier REYES, Helsinki (FI)

(21) Appl. No.: 14/881,697

(22) Filed: Oct. 13, 2015

(30) Foreign Application Priority Data
Nov. 18, 2014 (FI) 20140309

(51) Int. Cl. G06F 3/041

(52) U.S. Cl. CPC G06F 3/0416

(57) ABSTRACT

The invention relates to novel types of computing devices, their operating systems, and their user interfaces. The invention is especially related to methods and systems concerning user interfaces of touch screen based devices.

### BACKGROUND OF THE INVENTION

The invention relates to novel types of computing devices, their operating systems, and their user interfaces.

There exists many different types of computing devices for different usage situations, and different user interfaces. An example of a very common type of computing device is a typical so-called PC, personal computer, which typically has a display, keyboard and mouse for enabling user interaction with the computer. Typical personal computer operating systems such as Microsoft Windows, Apple OS X and Linux have so called indirect manipulation user interfaces that are designed to be used with a mouse, touchpad or another pointing device, and a keyboard. In such interfaces, the users act on objects of the interface by directing a pointer to the objects using the mouse, touchpad or another pointing device.

Another common type of devices are touch screen devices such as smartphones and tablets. In these devices, the user interacts with the device using its touch screen. These devices typically have so called direct manipulation user interfaces. In such interfaces, the users manipulate objects of the interface by pointing directly at the objects with their fingers.

Many models of known touch screen devices such as smartphones and tablets allow connection of an external screen to the device. An external screen can typically be used to replicate the image on the touch screen of the device, or to display images under control of applications executed on the device, for example for displaying a slide show. However, known solutions do not provide for full use of both the built in touch screen and the connected external screen at the same time.

### BRIEF DESCRIPTION OF THE DRAWINGS

Various embodiments of the invention will be described in detail below, by way of example only, with reference to the accompanying drawings, of which

FIG. 1 illustrates a computing device according to a first aspect of the invention, and

FIG. 2 illustrates a method according to a further aspect of the invention.

### DETAILED DESCRIPTION

### 1. Certain Methods for Use in an User Interface of a Computing Device

The following description concerns certain methods in a portable computing device having a touch screen display. The portable computing device may comprise a CPU, random access memory, mass memory such as flash memory or other non- volatile memory, communication circuitry, a touch screen display, and a rechargeable battery or other power source. The communication circuitry can comprise for example circuitry for wireless communication, circuitry for wired communication, or for example circuitry for optical communication. The wireless communication circuitry can advantageously be able to communicate over a WLAN, WiMax, cellular, Bluetooth and/or any other type of wireless communication standard. The wired communication circuitry can advantageously be able to communicate over an Ethernet link, an USB link, or any other preferably high-speed link. The circuitry for optical communication can advantageously be able to communicate over an optical fiber or through any other optical device. The portable computing device can advantageously also further comprise one or more cameras.

In various advantageous embodiments of the invention, the computing device has functionality for connecting to an external display, i.e. software and circuitry for creating a signal for an external display. The connection can be made in various ways, for example through a cable connection, or over a wireless connection.

In an advantageous embodiment of the invention, the computing device has a direct manipulation user interface on its touch screen display, in which the user directly points at objects on the interface with his fingers in order to select or otherwise manipulate them. This is, at the time of writing of this patent application, a common mode of operation on handheld mobile computing devices, and as such, well known to a man skilled in the art. However, when the mobile computing device is connected to an external display, the mobile computing device displays an indirect manipulation user interface on the external display, while allowing the use of the touch screen of the mobile computing device as a trackpad in order to control the user interface on the external display. In other words, the computing device comprises functionality for changing from the use of a direct manipulation user interface to the use of an indirect manipulation user interface.

In a further advantageous embodiment of the invention, the touch screen display of the computing device is used to display visual cues and/or user interface elements and/or objects of the user interface even in a situation, when the computing device is connected to an external display, and the computing device provides an indirect mode user interface on the external display. The touch screen display can advantageously display visual cues associated with certain actions being performed by the user while using the touch screen display as a trackpad. These visual cues can advantageously be simple cues, for example displaying colors or indicating movement, that the user is able to perceive with his peripheral vision even when his focus is on the user interface on the external display. Such visual cues can be e.g. feedback on a current action, or for example signals about the current mode in the user interface. For example, the touch screen display can indicate with a certain color or a certain icon that the user interface on the external display is in selection mode, in which the user can select objects in the interface. For a further example, the touch screen display can indicate with some another color or an icon that after copying an object or for example some text in the user interface on the external display, that the user is now able to paste the copied object or text.

In an even further advantageous embodiment of the invention, the touch screen display of the computing device includes functionality for haptic feedback. In such an embodiment, the computing device can give feedback to the user about the current actions in the user interface on the external display connected to the computing device through the touch sense in the user's fingertips. There are many different ways to provide haptic feedback known by a man skilled in the art, such as vibration, or use of electric fields between layers in the touch screen display. The invention is not limited to any specific technology of providing haptic feedback.

In an even further advantageous embodiment of the invention, the touch screen display of the computing device is used to display elements of the user interface even when the computing device provides the user interface on the external display connected to the computing device. For example, one or more buttons of the user interface can be displayed on the touch screen display. In such an embodiment, the computing device provides an user interface that is partially a direct manipulation user interface—i.e. the buttons or other elements, that are directly manipulable by the user, on the touch screen display—and partially an indirect manipulation user interface on the external display.

In a still further advantageous embodiment of the invention, in a situation where an external display is connected to the computing device and an indirect manipulation user interface is provided by the computing device on the external display, a first area of the touch screen display is dedicated for direct manipulation of interface objects, while a second area of the touch screen display is dedicated for indirect manipulation of an indirect manipulation user interface on the external display. This arrangement has the advantage that a clear delineation of which area of the touch screen display performs which actions makes it easy for the user to use both functionalities—the directly manipulable elements on the touch screen display as well as the area of the touch screen display that the user can use as a trackpad for controlling the user interface on the external display.

In a still further advantageous embodiment of the invention, the delineation of whether an area of the touch screen display of the computing device is used for direct manipulation of an user interface element or whether the area is used for indirect manipulation of the interface on the external display, is not constant but may change from direct to indirect manipulation mode during certain actions or chains of actions being performed on the user interface.

In a still further advantageous embodiment of the invention, the mobile computing device allows the user to move user interface elements or objects from the external display to the touch screen of the computing device for later use. For example, a user may opt to move an often used button to the touch screen display in order to have it easily reachable and clickable. For a further example, a user can use the touch screen display as a temporary storage for user interface objects by copying or moving an object from the external display to the touch screen display, thus storing the object for later manipulation such as dragging back to the external display.

In a still further advantageous embodiment of the invention, the user interface automatically places certain predetermined user interface elements or objects on the touch screen display while the computing device provides the main user interface on an external display connected to the computing device. This predetermination can be effected for example through certain rules and heuristics followed by the user interface, or for example by the developer of a software application who can indicate certain user interface elements to be preferably moveable to the touch screen display. Further, this predetermination can also be performed by the user, for example by selecting a set of preferences, a style sheet, or another listing of how certain element should be displayed to the user.

In an even further advantageous embodiment of the invention, the computing device has functionality to detect which kind of external display it has been connected to, and adjust the user interface mode between direct and indirect accordingly. For example, if the computing device is connected to an external display which does not have touch screen functionality, the computing device provides an indirect manipulation interface on the external display. However, if the external display has touch screen functionality, the computing device provides a direct manipulation interface on the external display. Such an embodiment provides the user a tablet- like method of operation, when a small computing device is attached to a larger external touch screen display.

2. Certain Further Aspects of the Invention

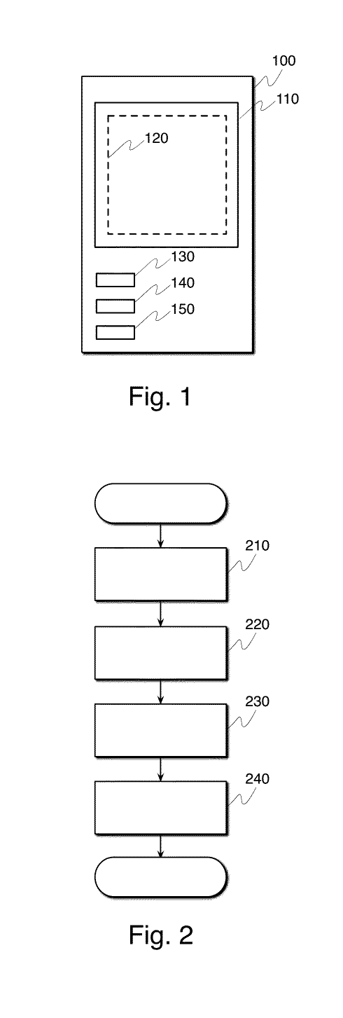

According to a first aspect of the invention illustrated in FIG. 1, there is provided a computing device 100 having a touch screen display 110 and arranged to display a direct manipulation user interface 120 on the touch screen display, and having circuitry 130 for driving an external display connectable to the computing device. According to a first advantageous embodiment of the invention, the computing device comprises functionality 140 for providing an indirect manipulation user interface on an external display connected to the computing device, and functionality 150 allowing the use of the touch screen display of the computing device as an input device for using said indirect manipulation user interface.

According to a second advantageous embodiment according to this first aspect of the invention, the computing device further comprises functionality for providing at least one user interface element on the touch screen display of the computing device in a situation, where an external display is connected to the computing device and the computing device provides an indirect manipulation interface on the external display.

According to a further advantageous embodiment according to this first aspect of the invention, the computing device further comprises functionality for allowing the direct manipulation of said at least one user interface element on the touch screen display of the computing device by the user.

According to a further advantageous embodiment according to this first aspect of the invention, the computing device further comprises functionality for providing visual and/or haptic cues on the touch screen display of the computing device in a situation, where an external display is connected to the computing device and the computing device provides an indirect manipulation interface on the external display.

According to a second aspect of the invention illustrated in FIG. 2, a method in a computing device for providing an user interface is provided. According to an advantageous embodiment of this second aspect of the invention, the method comprises at least the steps of

detecting 210 whether an external display is connected to the computing device,

providing 220 an indirect manipulation user interface to an external display connected to the computing device, and

receiving 230 input events from a touch screen display of the computing device for controlling said indirect manipulation user interface and controlling said indirect manipulation user interface as a response to said input events.

According to a further advantageous embodiment according to this second aspect of the invention, the method further comprises at least the step of providing at least one user interface element on a touch screen display of the computing device in a situation, where an external display is connected to the computing device and the computing device provides an indirect manipulation interface on the external display.

According to a third aspect of the invention, a non-transitory computer readable medium is provided. According to an advantageous embodiment of the invention, the non-transitory computer readable medium has stored thereon a set of computer executable instructions for execution in a computing device having a touch screen display, said instructions causing a processor to
detect whether an external display is connected to the computing device,
provide an indirect manipulation user interface to an external display connected to the computing device, and
receive input events from a touch screen display of the computing device for controlling said indirect manipulation user interface and control said indirect manipulation user interface as a response to said input events.

According to a further advantageous embodiment of this third aspect of the invention, the non-transitory computer readable medium further comprises instructions for causing a processor to provide at least one user interface element on a touch screen display of the computing device in a situation, where an external display is connected to the computing device and the computing device provides an indirect manipulation interface on the external display.

In view of the foregoing description it will be evident to a person skilled in the art that various modifications may be made within the scope of the invention. While a preferred embodiment of the invention has been described in detail, it should be apparent that many modifications and variations thereto are possible, all of which fall within the true spirit and scope of the invention.

1. A computing device having a touch screen display and arranged to display a direct manipulation user interface on the touch screen display, and having circuitry for driving an external display connectable to the computing device, comprising
functionality for providing an indirect manipulation user interface on an external display connected to the computing device, and
functionality allowing the use of the touch screen display of the computing device as an input device for using said indirect manipulation user interface.

2. A computing device according to claim 1, further comprising functionality for providing at least one user interface element on the touch screen display of the computing device in a situation, where an external display is connected to the computing device and the computing device provides an indirect manipulation interface on the external display.

3. A computing device according to claim 2, further comprising
functionality for allowing the direct manipulation of said at least one user interface element on the touch screen display of the computing device by the user.

4. A computing device according to claim 1, further comprising
functionality for providing visual and/or haptic cues on the touch screen display of the computing device in a situation, where an external display is connected to the computing device and the computing device provides an indirect manipulation interface on the external display.

5. A method in a computing device for providing an user interface, comprising at least the steps of
detecting whether an external display is connected to the computing device,
providing an indirect manipulation user interface to an external display connected to the computing device, and
receiving input events from a touch screen display of the computing device for controlling said indirect manipulation user interface and controlling said indirect manipulation user interface as a response to said input events.

6. A method according to claim 5, comprising at least the step of providing at least one user interface element on a touch screen display of the computing device in a situation, where an external display is connected to the computing device and the computing device provides an indirect manipulation interface on the external display.

7. A non-transitory computer readable medium having stored thereon a set of computer executable instructions for execution in a computing device having a touch screen display, said instructions causing a processor to
detect whether an external display is connected to the computing device,
provide an indirect manipulation user interface to an external display connected to the computing device, and
receive input events from a touch screen display of the computing device for controlling said indirect manipulation user interface and control said indirect manipulation user interface as a response to said input events.

8. A non-transitory computer readable medium according to claim 7, comprising further instructions for causing a processor to provide at least one user interface element on a touch screen display of the computing device in a situation, where an external display is connected to the computing device and the computing device provides an indirect manipulation interface on the external display.
